(19) United States
(12) Patent Application Publication
(10) Pub. No.: US 2005/0150899 A1
(43) Pub. Date: Jul. 14, 2005

(54) Business card display and dispenser

(76) Inventor: James B. Demido, Troy, OH (US)

Correspondence Address: Harry I. Leon, 924 Bowen St., N.W., Atlanta, GA, 30318, US

(21) Appl. No.: 10/753,300

(22) Filed: Jan. 8, 2004

(51) Int. Cl. B65H 1/00; G07F 11/00; A47F 1/00; B65H 1/08

(52) U.S. Cl. 221/60; 221/102

(57) ABSTRACT

A holder with a plurality of pockets for displaying and dispensing, in one location, a variety of business cards. Particularly suitable for businesses in which a number of professional people share a common lobby or waiting room, the holder, when filled with their respective business cards, offers clients or patients a convenient way to keep in touch. It also can be used to advertise professional and other services in shopping malls, restaurants, supermarkets and the like. The holder comprises a frame with a shoulder which defines a generally rectangular opening. Mounted within the opening are rows of shallow pockets, each pocket being defined by an elongated transparent front panel, a back panel, and except for the lowermost pocket, a spacer. The spacers not only separate the front and back panel and are affixed thereto, but also forms the bottom of the individual pockets. Separated from the back panel by a distance which is approximately equal to that between the front and back panels in each of the pockets above it, the front panel in the lowermost pocket is affixed along its lower edge to the shoulder itself instead of to a spacer. Spacing between rows of pockets is such that when business cards are placed in on end in the lower pockets the top of the card protrudes outwardly a short distance past the lower edge of the front panel in the next higher pocket, overlapping it a fraction of and inch and allowing the card to be removed easily.

### BACKGROUND OF THE INVENTION

1. Field of the Invention

The present invention relates to business card holders and dispensers.

For medium and large professional offices, there is a need to have a multiple business card display and dispenser. Particularly suitable for use in the lobby or waiting room, such display/dispensers would allow clients or patients to easily keep in touch with the professional person they are visiting.

There is also a need for a business card display/dispenser to advertise business, professional and other services. These display/dispensers can be placed in convenient public locations such as malls, restaurants, and supermarkets.

2. Description of Related Art

At the present time, most business card holders dispense only a single person's business card. Multiple card holders for displaying a variety of cards have been limited to the workplace of the user. A typical example of a multiple card holder is the organizer by Basmajian, U.S. Pat. No. 5,393,157 issued Feb. 28, 1995. Basmejian discloses a card organizer for file folders.

### SUMMARY OF THE INVENTION

The object of the present invention is to provide a low cost, attractive business card holder/dispenser for use in professional offices, service industries, and the like, in which a plurality of cards from each of a variety of sets of cards can be clearly displayed and from which individual cards can easily be removed.

A further object of this invention is to provide inexpensive advertisement space in public areas for those entities which utilize business cards in marketing their services.

The improved business card holder and dispenser, according to the present invention, resembles a picture frame in which are mounted, instead of a picture, rows of shallow pockets. Each pocket is defined by an elongated transparent front panel, a back panel, and spacing means which not only separates the front and back panels but also forms the bottom of the individual pocket. The height of each front panel is such that it only partially covers any business card held on end behind it; and the spacing between contiguous rows of pockets is substantially less than either of the two longer edges of a business card, so that a portion of each card held in one of the pockets is exposed and protrudes outwardly to facilitate removal of the card.

In the preferred embodiment, the back panel is rigidly attached to the backside of a grooved frame which defines a generally rectangular opening; a shoulder formed in the frame comprises spacing means for separating the front panel of the lowermost row of pockets from the back panel. The spacing means separating the front and back panels in pockets other than the lowermost pocket comprises spacers, each spacer and the shoulder having approximately the same thickness. The spacers and the shoulder determine the width of their respective pockets and thereby the number of cards which can be held therein. In designs to date, these spacers have varied in width from 0.2 inch to 1.0 inch or larger depending on particular need. The technology disclosed herein allows for a wide variation in sizes.

Means for hanging the improved holder and dispenser from a wall or other vertical surface includes mechanical fasteners attached to the grooved frame or, alternately, to the back panel. In an alternate embodiment, the holder is free-standing, supported by a fold-out leg connected by a hinge to the back panel or frame.

### BRIEF DESCRIPTION OF THE DRAWINGS

FIG. 1 is a perspective view of the business card holder and dispenser according to the present invention;

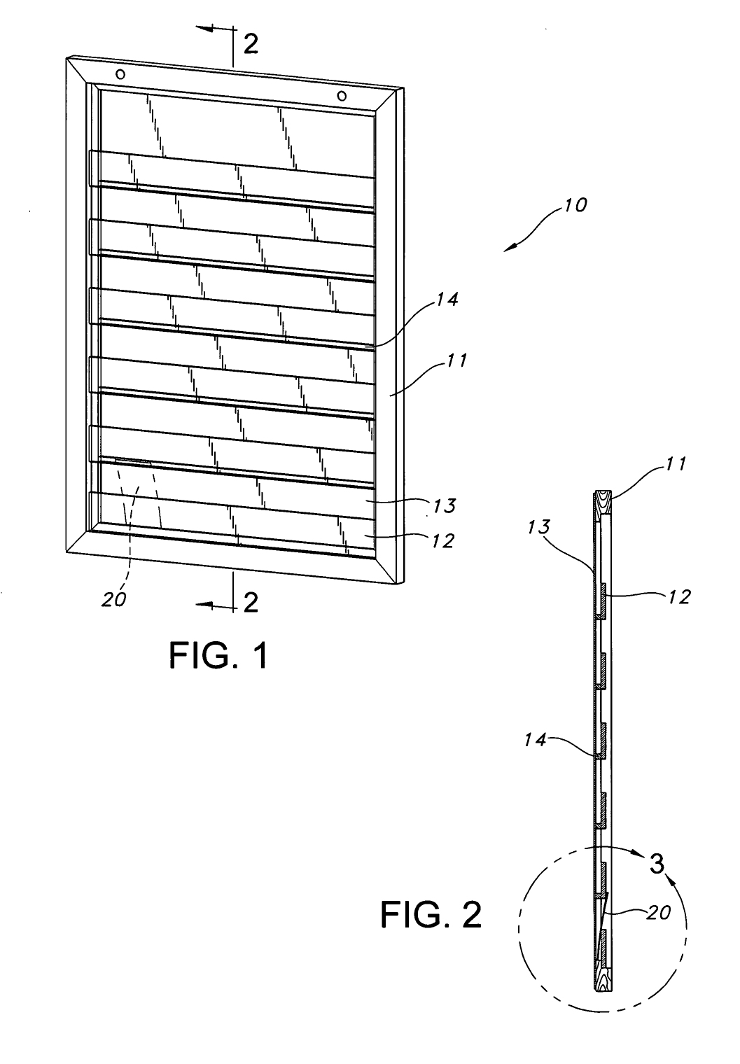

FIG. 2 is a cross section view of the holder and dispenser according to FIG. 1, the cross section being taken on line 2-2 of FIG. 1.

FIG. 3 is a cross section view of a fragmentary portion of the holder and dispenser according to FIG. 1, the cross section being the same one which is encircled by arc 3-3 in FIG. 2 but on an enlarged scale; a business card held on end within the lowermost pocket being shown for clarity of illustration and forming no part of the invention;

FIGS. 4 and 5 are front and rear views, respectively, of the holder and dispenser according to FIG. 1; and

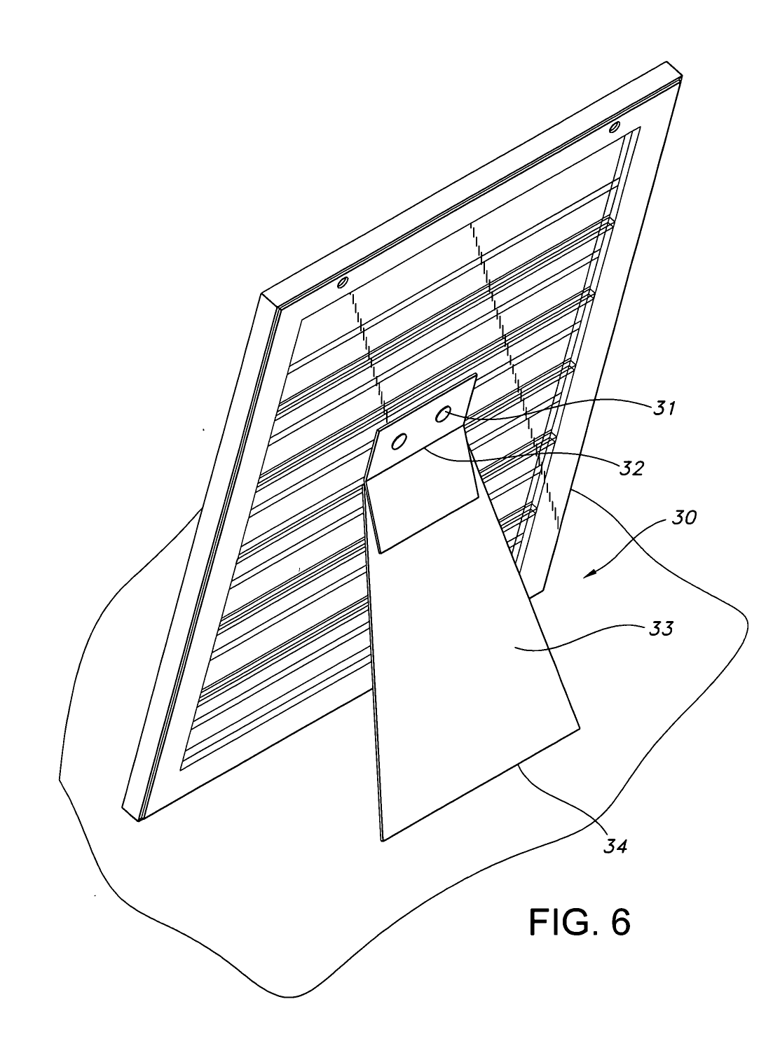

FIGS. 6 and 7 are right side perspective and elevational views, respectively, of an alternate embodiment of the business card holder and dispenser according to the present invention, the alternate embodiment including a fold-out leg for supporting it on a horizontal surface.

### DETAILED DESCRIPTION OF THE PREFERRED EMBODIMENT

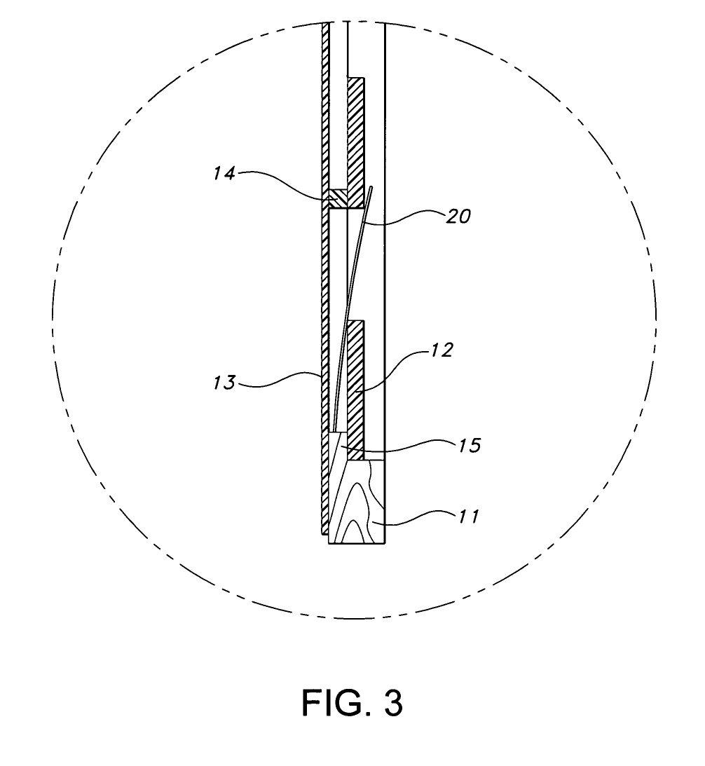

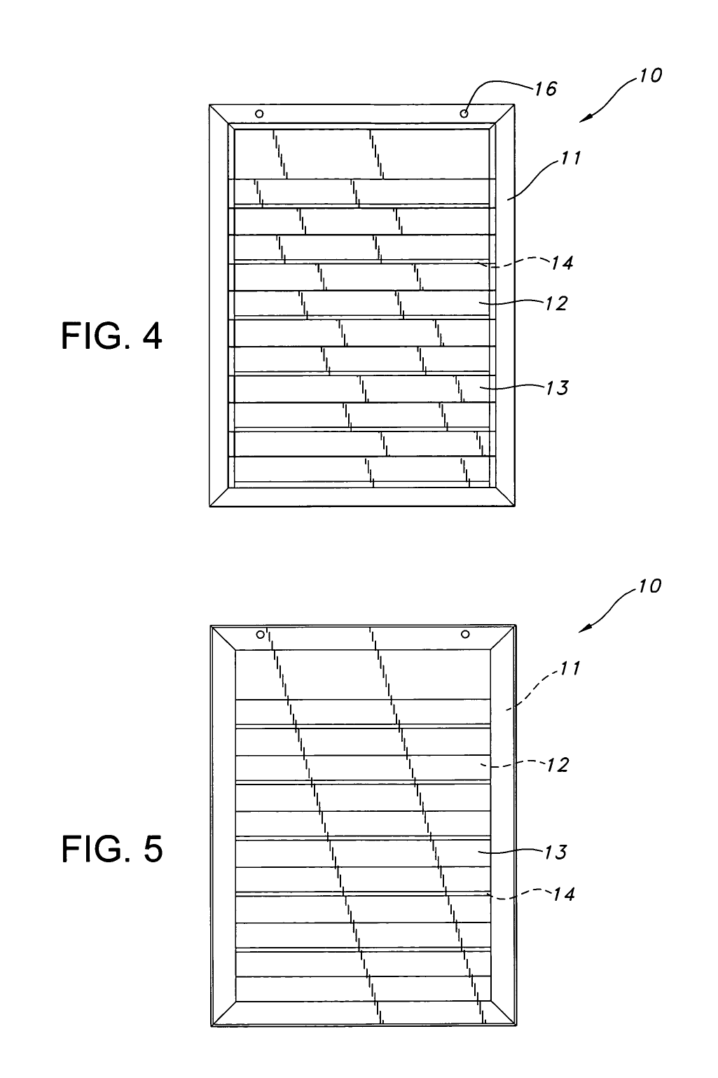

In the drawings, an improved business card holder and dispenser indicated generally by the reference number 10 comprises a generally rectangular frame 11, a back panel 13 and at least two rows of pockets. Rigidly attached along each of its four edges to a frame 11, the back panel 13 is preferably formed of transparent material (FIGS. 2, 3 and 5). With the exception of the lowermost row of pockets, each pocket is defined by the back panel 13, a front panel 12 and a bottom spacer 14 (FIGS. 2 and 3). A shoulder 15 formed in the frame 11 and having approximately the same thickness as the bottom spacers 14, together with the front and back panels 12, 13, comprises the lowermost row of pockets. Distal ends of each of the front panels 12, as well as the lower edge of the lowermost front panel, are affixed by glue or mechanical fasteners to the shoulder 15. Similarly, the bottom spacers 14 are rigidly attached to contiguous front panels 12 and to the back panel 13.

In the preferred embodiment, each panel is made of transparent material and, except for the lowermost front panel, measures generally one-half the width of a standard 3.5 inch by 2 inch business card or about 1¾ inches height. The lowermost front panel 12 is preferably about 1⅞ inches high so that its lowermost edge abuts the entire vertical face of the shoulder 15 (FIG. 3). The spacers 14, which are fabricated from an elongated rod or, alternately, cut from plastic material, are preferably ¼ inches in height and may vary in thickness from ⅛ inch to an 1.0 inch or more depending on number of cards 20 which are to be held. The spacers 14 are attached to the back panel 13 at intervals of approximately 3⅜ inches. Contiguous pairs of spacers 14 are spaced apart a distance which is shorter than the width of a standard business card by approximately ⅛ inch.

The back panel 13, supports at least one row of pockets. These pockets are formed by a front panel 12 and a bottom spacer 14 that attaches the front 12 to the back 13. The front 12 is also supported by glue or mechanical fasteners to the shoulder 15 cut in the frame. In the preferred embodiment Cards 20 placed in one of the lower pockets with their shorter edges down protrude outwardly pass the lower edge of the front panel 12 for the pocket immediately above it (FIG. 3). This protrusion amounts to approximately ⅜ inch of the top of each card 20, facilitating its removal from the holder and dispenser 10.

These holders and dispenser 10 can be made in a wide variety of sizes. Some typical sizes in which the card dispenser 10 can be embodied are given in the table below:

| Stacks | No. of Rows | Width, inch | Height, inch |
|---|---|---|---|
| 12 | 3 | 11 | 13¼ |
| 20 | 4 | 13 | 16 |
| 42 | 4 | 17½ | 23¼ |
| 60 | 6 | 23½ | 23¼ |
| 84 | 7 | 28¼ | 26½ |
| 120 | 8 | 35¼ | 29¼ |

The maximum number of cards that can be held in each stack is determined by the spacer width.

These holder/dispensers 10 can be made from a wide range of materials. The frame 11 can made be made from wood, plastic or metal with a typical frame thickness being ¾ inch. The back panel 13 may be made from plastic, wood or metal.

The preferred embodiment of the holder/dispenser is made for vertical wall mounting using holes 16 defined by the frame 11 or it could be hung using standard framed picture mounting means.

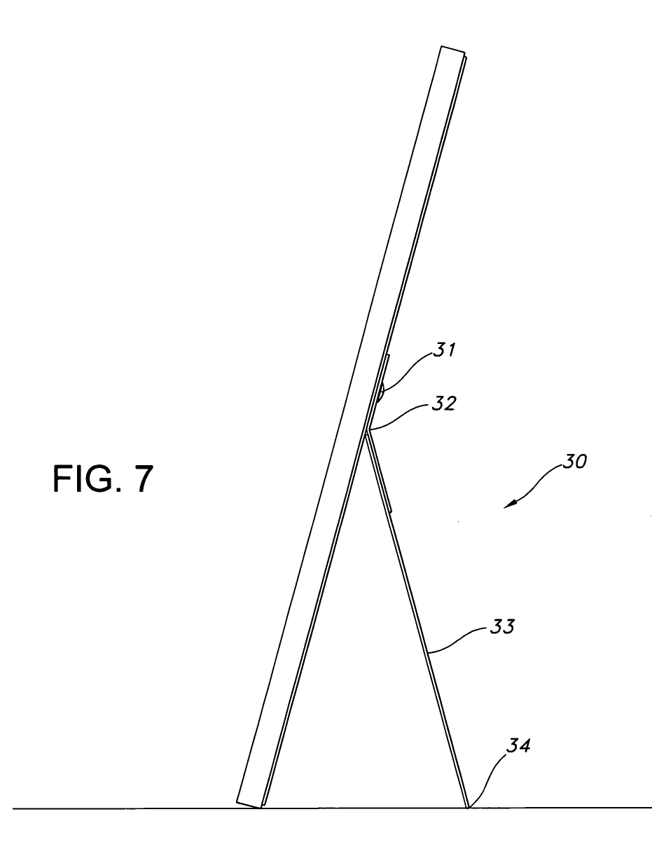

An alternate embodiment of the holder/dispenser 10 is shown on FIGS. 6 and 7. In this embodiment the holder/dispenser is designed for use on a horizontal surface such as a table. This embodiment comprises a fold-out leg 33 having a foot 34 that rests on the horizontal surface. A hinge 32 attaches to the back panel 13 either by glue, weld or mechanical fastener 31.

It is understood that those skilled in the art may conceive other applications, modifications and/or changes in the invention described above. Any such applications, modifications or changes which fall within the purview of the description are intended to be illustrative and not intended to be limitative. The scope of the invention is limited only by the scope of the claims appended hereto.

1. A business card holder and dispenser, which comprises:
(a) a frame which defines a shoulder and a generally rectangular opening bounded by the shoulder;
(b) a back panel affixed to the frame;
(c) upper and lower elongated transparent front panels, which are spaced apart and which are disposed horizontally within the frame, distal ends of each front panel being affixed to opposing faces of the shoulder; and
(d) at least one bottom spacer having approximately the same thickness as the shoulder, the spacer being disposed horizontally and rigidly attached to the back panel and to the lower front panel, each bottom spacer, contiguous front panel and the back defining a shallow pocket for holding a plurality of business cards; the bottom spacer attached to the lower front panel being spaced apart from the lowermost portions of the upper front panel by a distance which is a fraction of an inch shorter than the width of a standard business card, so that when the card rests on its shorter edge on the bottom spacer, the card protrudes past said lowermost portion, allowing the card to be removed easily.

2. The business card holder and dispenser according to claim 1, which further comprises an additional elongated, transparent front panel, which is spaced apart and disposed horizontally beneath the lower front panel, the additional front panel having its distal ends and lowermost edge affixed to the shoulder; the shoulder, the additional front panel and the back panel defining a shallow pocket for holding a plurality of business cards, lowermost portions of the lower front panel being spaced apart from the juncture of said lowermost edge and the shoulder by a distance which is a fraction of an inch shorter than the width of a standard business card, so that when the card rests on its shorter edge on the shoulder, the card protrudes outwardly past the lowermost portions of the lower front panel, allowing the card to be removed easily.

3. The business card holder and dispenser according to claim 1, which further comprises means for supporting the frame on a horizontal surface, the supporting means including a fold-out leg hingedly connected to the back panel.

4. A business card holder and dispenser which comprises:
(a) A plurality of rows of pockets, each pocket being defined by a solid back panel and front panel made from a transparent material, the front panel partially covering the back panel; and
(b) means, including a spacer, for attaching each front panel to the back panel, each spacer forming the bottom of one of the pockets, the rows of pockets being arrayed vertically and so spaced apart that when a business card is placed on end in one of the lower rows, a portion of the card protrudes over the bottom edge of the front panel of the next upper row of pockets, allowing the cards to be easily removed.

5. The business card holder, according to claim 4, which further comprises a frame which supports the back panels allowing the holder to be mounted on a vertical support surface.

6. A business card holder according to claim 4, which further comprises means for supporting the holder on a horizontal surface.

7. The business card according to claim 6 wherein the supporting means comprises a fold out leg attached to the back panel.
